(19) United States
(12) Patent Application Publication
(10) Pub. No.: US 2016/0105698 A1
(43) Pub. Date: Apr. 14, 2016

(54) CHANNEL-BASED LIVE TV CONVERSION

(71) Applicant: FiveByFive, Inc., San Jose, CA (US)

(72) Inventor: George Tang, San Jose, CA (US)

(21) Appl. No.: 14/879,875

(22) Filed: Oct. 9, 2015

Related U.S. Application Data
(60) Provisional application No. 62/061,975, filed on Oct. 9, 2014.

(51) Int. Cl. H04N 21/2343; H04N 21/2187; H04N 21/4627; H04N 21/254; H04N 21/242; H04N 21/472; H04N 21/2665; H04N 21/258; H04N 21/81; H04N 21/234; H04N 21/466; H04N 21/25; H04N 21/2347; H04N 21/4408; H04N 21/6334; G11B 27/10; H04N 21/845; H04N 5/265; H04N 21/422; H04N 21/431; H04N 21/61

(52) U.S. Cl. CPC H04N 21/234309; H04N 21/6125; H04N 21/2187; H04N 21/4627; H04N 21/2541; H04N 21/242; H04N 21/47202; H04N 21/2665; H04N 21/25875; H04N 21/812; H04N 21/23424; H04N 21/4668; H04N 21/252; H04N 21/2347; H04N 21/4408; H04N 21/6334; G11B 27/10; H04N 21/8456; H04N 5/265; H04N 21/42204; H04N 21/4312

(57) ABSTRACT

Several embodiments include an Internet-based video delivery system that retains channel browsing capabilities. The video delivery system can include a backend server system. The backend server system can receive input feeds from channel programming of content providers. The backend server system can encode the input feeds into video streams deliverable over the Internet. The backend server system can transmit a video stream to multiple user devices in substantially real-time. The backend server system can also record the video stream in a media storage protected by an authentication engine. The backend server system can then generate a channel-side control interface, available to an authorized account associated with the content providers, to enable remote management of live distribution of the video streams and/or on-demand distribution of the recorded video streams.

### CROSS-REFERENCE TO RELATED APPLICATION

This application claims the benefit of U.S. Provisional Patent Application Ser. No. 62/061,975, filed Oct. 9, 2015, and the subject matter thereof is incorporated herein by reference thereto.

### RELATED FIELDS

At least one embodiment of this disclosure relates generally to a video distribution system, and in particular to Internet-based video distribution systems.

### BACKGROUND

Traditional TV programming providers are inflexible. Under traditional schemes, content is provided according to time slots dictated by the content providers. The ability to watch content at a later time depends on a recording devices, such as digital video recorders (DVRs), which are expensive and bulky.

Through the advancement of the Internet, alternative video content is also becoming available. For example, there are now video subscription services that provides video on demand, such as Netflix™, Youtube™, or Hulu™. However, while the on-demand model provides significantly more freedom for the video consumers, it also takes away the control of video distribution traditionally held by the TV programming providers.

### DISCLOSURE OVERVIEW

Disclosed is a smart streaming system. This smart streaming system comprises a backend video conversion system (e.g., one or more computer servers) that converts video feeds of TV channels in real-time to stream over the Internet. The backend video conversion system can decode one or more input feeds (e.g., Over-the-Air transmission or a TV cable feed) simultaneously and re-encoding them into one or more web accessible video streams. This backend video conversion system can customize each video stream provided to the video consumers. For example, the backend video conversion system can embed a different targeted advertisement into different video streams for at least two different video consumers. The video streams provided to the video consumers are synchronized to the live TV channels as dictated by the TV programming providers. Conversion of the TV channel's programming can be considered “live” when a backend server system begins converting content into streamable encoding when the content becomes available from the content provider (e.g., TV channels). That is, the content does not necessarily have to be recorded live. However, the disclosed smart streaming system can indeed convert and stream videos based on recorded-live content.

The smart streaming system also enables streaming of 4K video that is otherwise bandwidth limited by Over-the-Air digital broadcast systems. The smart streaming system combines the benefits of on-demand video to the consumers and the benefits of retaining the control of TV programming by the TV programming providers. The smart streaming system protects the interests of the content providers by limiting the video streams to be non-downloadable. Nevertheless, the smart streaming system enables a video consumer to watch content at a later time or a different geographical location via a secured on-demand video stream bookmarking system.

The video stream bookmarking system can be part of the backend video conversion system. While the backend video conversion system is decoding the input feeds and re-encoding them into web accessible video streams, the video stream bookmarking system can store the re-encoded video streams in a cloud storage server. The cloud storage server is then able to stream the web accessible video streams on demand upon request, subject to an authentication engine implemented by the video stream bookmarking system.

The authentication engine is used to determine whether a requesting device can access at least one of the web accessible video streams from the cloud storage server. The authentication engine can extract user profile information (e.g., user ID or user type/access level), request context information (e.g., request time of day or day of year, or communication protocol used for the request), and device information (e.g., device type, device location, or connection bandwidth) associated with the requesting device. The authentication engine can then use the user profile information, request context information, device information, or any combination thereof, to determine whether to stream the web accessible video streams to the requesting device. In several embodiments, the authentication engine can include an access limitation setting associated with each user, each cloud storage server, and/or each web accessible video stream.

In several embodiments, the video stream bookmarking system provides a media control interface for content providers to manage the stored web accessible video streams on the cloud storage server. The media control interface enables the video stream bookmarking system to act as an agent of a TV programming provider instead of a competitor. The media control interface also enables the TV programming providers or content providers to limit the amount of access to the web accessible video streams. For example, the providers can limit the number of accesses per video stream, number of users who can access a video stream, amount of bandwidth allocated for each user, data size of total “recallable” video streams per user, or any combination thereof.

Some embodiments of this disclosure have other aspects, elements, features, and steps in addition to or in place of what is described above. These potential additions and replacements are described throughout the rest of the specification

### BRIEF DESCRIPTION OF THE DRAWINGS

FIG. 1 is a system environment diagram of a smart streaming system, in accordance with various embodiments.

FIG. 2 is a functional block diagram of a backend video conversion system, in accordance with various embodiments.

FIG. 3 is a functional block diagram of a local streaming unit, in accordance with various embodiments.

FIG. 4 is a block diagram of a smart remote controller, in accordance with various embodiments.

FIG. 5 is an expanded system environment diagram for using the smart streaming system to distribute product electronic incentive identifiers, in accordance with various embodiments.

FIG. 6 is a block diagram of an example of a computing device, which may represent one or more computing device or server described herein, in accordance with various embodiments.

FIG. 7 is an example of a video viewing interface generated by the local streaming unit, in accordance with various embodiments.

FIG. 8 is a block diagram illustrating a local streaming unit, in accordance with various embodiments.

FIG. 9 is a functional block diagram illustrating a smart remote controller, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

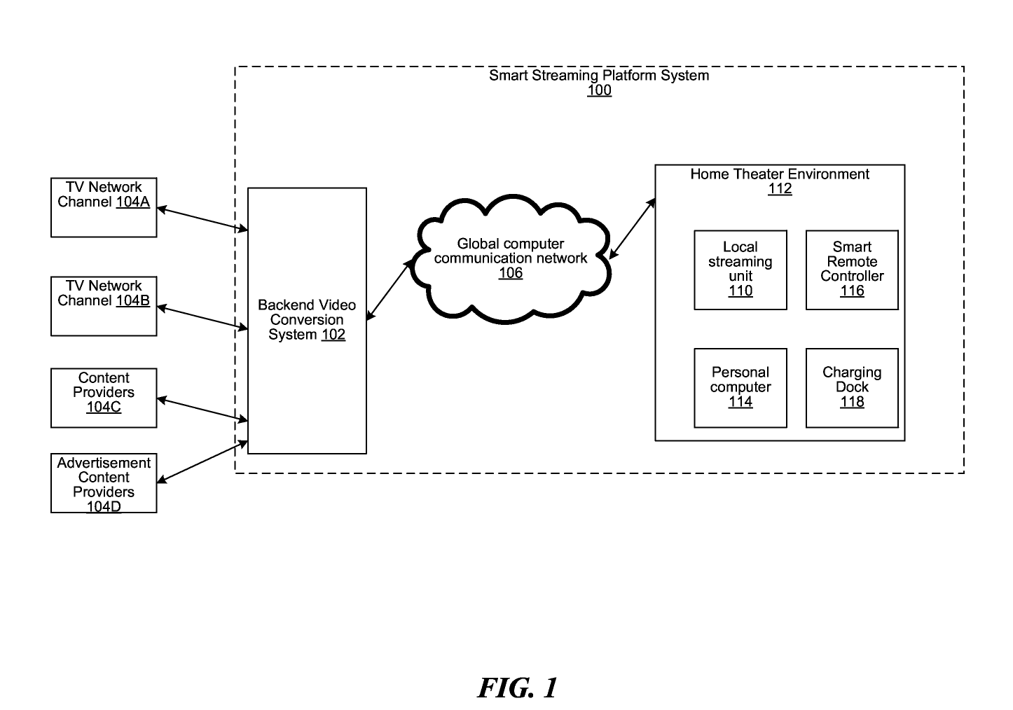

FIG. 1 is a system environment diagram of a smart streaming platform system 100, in accordance with various embodiments. The smart streaming platform system 100 can include a backend video conversion system 102. The backend video conversion system 102 can be connected to one or more TV network channels (e.g., a TV network channel 104A, a TV network channel 104B, etc., one or more content providers 104C, one or more advertisement content providers 104D, collectively as the “content provider 104”). For example, the Content providers 104 can include an over-the-air channel, a satellite dish channel, a DSL channel, a fiber channel, a cable channel, or any combination thereof. The backend video conversion system 102 can receive one or more input feeds of real-time video data from the Content providers 104.

In several embodiments, the backend video conversion system 102 can also receive other video content via a global computer communication network 106, such as the Internet. The global computer communication network 106 can be provided by an Internet service provider (ISP). For example, content providers and advertisement providers can provide on-demand video content to the backend video conversion system 102.

In several embodiments, the backend video conversion system 102 can interact with one or more computing devices authenticated to be associated with the TV programming providers. These interactions can be facilitated through the content providers 104 or the global computer communication network 106. These interactions, for example, enable the TV programming providers to maintain control over live conversion of the input feeds and subsequent storage of converted video streams in the backend video conversion system 102.

The backend video conversion system 102 can convert the real-time video data into web accessible video streams. For example, this can be accomplished by decoding the real-time video data, re-encoding the decoded video data into a web accessible video format, and streaming the web accessible video to one or more home theatre environments compatible with the backend video conversion system 102.

In at least one example, a local streaming unit 110 in a home theater environment 112 can request the backend video conversion system 102 to stream one or more of the web accessible videos. The local streaming unit 110 is then able to decode the web accessible videos and provide the decoded videos to one or more user computing devices (e.g., TVs, personal computers, laptops, tablets, smart phones, or any combination thereof). In another example, a personal computer 114 can request, via a web browser, the backend video conversion system 102 to stream one or more of the video accessible videos. In this example, the backend video conversion system 102 can stream the web accessible video via a web server module.

In several embodiments, the home theater environment 112 includes a smart remote controller 116. The smart remote controller 116 can enable interaction between the viewer (e.g., associated with a service subscription account) and a display screen coupled to the local streaming unit 110. The smart remote controller 116 can implement a trackpad to enable gesture control of the display contents on a TV set managed by the local streaming unit 110. The smart remote controller 116 can be charged wireless or via a wired connection utilizing a charging dock 118. In The smart remote controller 116 can have a touchscreen.

The touchscreen enables the smart remote controller 116 to detect hand gestures corresponding to active commands to the local streaming unit 110. The smart remote controller 116 can also include one or more other sensors, such as an inertial motion sensor, a microphone, a temperature sensor, a gyroscope, a light sensor, a camera, a force sensor, an electric charge sensor, or any combination thereof. The sensors can be used to determine video watching context at the home theater environment 112. For example, the inertial motion sensor or the microphone can be used to determine whether or not the video consumer is actively watching (e.g., detecting loud cheers or movements indicating waving the smart remote controller 116), passively watching (e.g., detecting movements indicating occasionally holding of the smart remote controller 116), or has left the home theater environment 112 entirely (e.g., lack of movement of the smart remote controller 116). For another example, the light sensor can be used to determine display setting (e.g., brightness and contrast level) of the video streams provided through the local streaming unit 110. For yet another example, the force sensor or the electric charge sensor can be used to detect whether or not the smart remote controller 116 has been placed back to its docking station. In some implementations, the local streaming unit 110 can turn off the TV display whenever the smart remote controller 116 has been placed back to its docking station.

In some embodiments, the local streaming unit 110 is capable of reproducing 4K content via hardware and/or software-based decoding (e.g., via HEVC/H.265 and/or VP10 standards). The 4K content can be encoded by the backend video conversion system 102 and streamed to the local streaming unit 110. In some embodiments, the local streaming unit 110 can also decode MPEG-4/H.264, MPEG-2, etc.

In order to minimize additional bandwidth consumption, and/or to minimize piracy, the local streaming unit 110 is capable to transcode source content (4K, Full-HD, HD, SD, etc.) into other format (HD or Full-HD) and broadcast locally to additional client devices (e.g., electronic tablet, smartphones, etc.), making the local streaming unit 110 as a gatekeeper and portal to access content hosted remotely. This function can be implemented as a consideration that the local streaming unit 110 might not have a TV set connected, therefore subscriber clients use alternative viewing devices.

The local streaming unit 110 can secure media content and/or programming using one or more of the following hardware ID and/or information to grant access: the local streaming unit 110's processor ID and/or processor serial number, Media Access Control (MAC) address from either a wireless network adapter or an Ethernet adapter of the local streaming unit 110, a basic input/output system (BIOS) serial number, a streaming service subscriber account ID, a streaming service subscriber account status (e.g., whether the status corresponds to an active paying subscription), or any combination thereof.

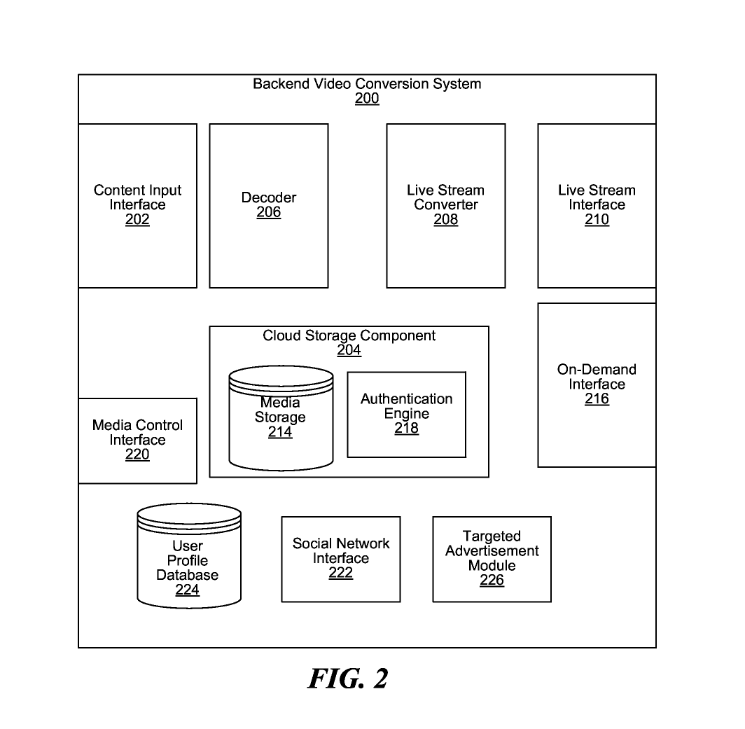

FIG. 2 is a functional block diagram of a backend video conversion system 200, in accordance with various embodiments. For example, the backend video conversion system 200 can be the backend video conversion system 102 of FIG. 1. The backend video conversion system 200 can include various hardware components that are configured by executable instructions.

For example, the backend video conversion system 200 can include a content input interface 202. The content input interface 202 may be coupled to one or more communication channel adapters. For example, the content input interface 202 can be coupled to a network adapter, such as an Ethernet network adapter. The content input interface 202 can be coupled to a dish network modem, a cable modem, a DSL modem, or any combination thereof.

The content input interface 202 receives real-time video data from one or more TV networks. The content input interface 202 can receive multiple TV channels from the same communication channel or from different communication channels. In several embodiments, the content input interface 202 can receive real-time or non-real-time media content from one or more advertisement providers and one or more content providers. In some embodiments, the non-real-time media content is saved and stored in a cloud storage component 204.

When receiving real-time video data, the content input interface 202 can provide the real-time video data synchronously to a decoder module 206. The decoder module 206 can decode (e.g., utilizing a decoding protocol associated with a communication channel), decompress (e.g., utilizing a decompression algorithm associated with a TV network), and/or decrypt (e.g., utilizing a cryptographic key associated with a TV network) the real-time video data. The decoder module 206 then provides the decoded real-time video data to a live stream converter 208 (e.g., with H265 transcoding capability and digital rights management (DRM) capability). In some embodiments, the content input interface 202 can directly provide the real-time video data to the live stream converter 208.

The live stream converter 208 encodes the decoded real-time video data into a web accessible video stream that can be digitally streamed to multiple target devices connected to a communication network, such as the Internet or a local area network (LAN), via a live stream interface 210. In some embodiments, the live stream converter 208 can buffer the decoded real-time video data in a memory device (e.g., volatile memory or solid state memory) while performing the encoding/conversion. In some embodiments, the live stream converter 208 can overlay, replace, combine, or insert media segments from real-time video data of multiple TV channels. In some embodiments, the live stream converter 208 can overlay, replace, combine, or insert media segments from non-real-time media data of other content providers or advertisement providers. For example, the live stream converter 208 can overlay, replace, combine, or insert an advertisement audio, text, image, or video into the web accessible video stream produced from real-time video data of a TV channel.

The live stream converter 208 can transcode channel programming content (e.g., news, sports events, special events, scheduled programming contents, such as sitcom, series, etc.) as the content becomes available to the backend video conversion system 200. In some embodiments, the live stream converter 208 can also convert media content in batch mode (e.g., movies, music, and/or music video media files) from one or more content sources (e.g., TV networks, content producers, movie studios, publishers, record labels, or any combination thereof). For example, a content source can provide the media files from a network address (e.g., a data center or a content delivery network (CDN)) or a physical data storage device at the premises of the backend video conversion system 200.

The live stream converter 208 can organize the transcoded videos in a media storage 214. For example, the transcoded videos can be organized by a relational database storing metadata and profiles of the transcoded videos (e.g., by genre, date, actors, directors, producers, origin, spoken language, etc.). The live stream converter 208 can utilize the relational database to curate the transcoded videos for live streaming or on-demand access.

In several embodiments, the live stream converter 208 can transcode media content under the H.265 and/or VP10 compression standards, using multi-bitrate (e.g., MPEG-Dash and Digital Rights Management (DRM) encryption supported by major industry standards, or proprietary methods and algorithms.

The live stream interface 210 can be an application programming interface (API) that may be accessed by a video streaming equipment, such as the local streaming unit 110 of FIG. 1. The live stream interface 210 can also implement a Web server that may be accessed by web browsers of one or more computing devices. In some embodiments, the live stream interface 210 provides the web accessible video stream simultaneously to one or more computing devices simultaneously or substantially simultaneously. In some embodiments, the live stream interface 210 can stagger the streaming of the web accessible video from one group of computing devices to another, for example, based on geographical regions. In some embodiments, the live stream interface 210 can synchronize the web accessible video streams with the real time video data received through the content input interface 202. In some embodiments, the live stream interface 210 can deliver the web accessible video streams at a constant delay or variable delay from the real-time video data.

In several embodiments, the cloud storage component 204 saves (i.e., records) the web accessible video streams into media files in the media storage 214. In some embodiments, the cloud storage component 204 is an independent computer server. In some embodiments, the cloud storage component 204 along with other components in the backend video conversion system 200 are implemented with one or more computing devices working in sync. At a later time, a computing device of a video consumer can request for at least a segment of the media file be streamed to the computing device. An on-demand interface 216 can process such requests. The on-demand interface 216 can retrieve information regarding a request and pass that information to an authentication engine 218. For example, the transcoded content files (e.g., video and/or audio) can be split into several fragmented files. In one example, the fragmented files can be 5 seconds worth of contents, or can be incremental at 10 seconds, 15 seconds, and/or 30 seconds, depending on the type of video contents. For example, sports content may be fragmented at 5 seconds worth, while movie content files or documentary media files may be fragmented at 15 or 30 seconds.

The live stream converter 208 can encrypt the fragmented files for digital rights protection. The live stream converter 28 can store the fragmented files in one or multiple locations (e.g., depending on the geographical location). Storage of the fragmented files is optimized to consider Quality of Service (QoS) of all contents files (e.g., storing files in data center(s) or CDN nearest to the backend video conversion system 200 or in multiple data centers closest to service areas of the backend video conversion system 200).

The authentication engine 218 is used to determine whether a requesting device can access at least one of the media files in the media storage 214 corresponding to the web accessible video streams. The authentication engine 218 can identify user profile information (e.g., user ID or user type/access level), request context information (e.g., request time of day or day of year, request media segment, or communication protocol used for the request), and device information (e.g., device type, device location, or connection bandwidth) associated with the requesting device based on the information from the on-demand interface 216. The authentication engine 218 can then use the user profile information, request context information, device information, or any combination thereof, to determine whether to stream the media file to the requesting device. In several embodiments, the authentication engine 218 can include an access limitation setting associated with each user, each cloud storage server, each web accessible video stream, and/or each TV channel.

In several embodiments, the streaming request can be based on an identifier of a TV channel and a time stamp (together as a “video stream bookmark”). The cloud storage component 204 can then stream a media file through the on-demand interface 216 by referencing a media segment in the media storage 214 corresponding to the TV channel and the timestamp of the streaming request.

In several embodiments, the backend video conversion system 200 provides a media control interface 220 for content providers to manage the stored media files managed by the cloud storage component 204. The media control interface 220 can enable an external device to configure the access limitation setting. The media control interface 220 enables the backend video conversion system 200 to act as an agent of a TV programming provider instead of a competitor. The media control interface 220 also enables the TV programming providers and content providers to limit the amount of access to the media files corresponding to the web accessible video streams. For example, the providers can limit the number of accesses per video stream, number of users who can access a video stream, amount of bandwidth allocated for each user, data size of total “recallable” video streams per user, or any combination thereof.

In various embodiments, the streaming of the live stream interface 210 and the on-demand interface 216 is configured to be non-downloadable. This is advantageous to protect the rights of the TV networks that are providing the real-time video data. This enables the backend video conversion system 200 to act as an agent of the TV networks.

The backend video conversion system 200 can include a social network interface 222. The social network interface 222 connects the backend video conversion system 200 to a social networking system. The social networking system enables the social network interface 222 to identify and link user profiles between the social networking system and a user profile database 224 maintained by the backend video conversion system 200. The user profile database 224 can maintain video viewing context and behavior collected both from the remote control and/or the social networking system.

The backend video conversion system 200 can include a targeted advertisement module 226. The targeted advertisement module 226 can select advertisement media segments to insert/encode into video streams provided to computing devices via the live stream interface 210 and/or the on-demand interface 216. For example, the targeted advertisement module 226 can receive a user profile type associated with an advertisement media segment from an advertiser or from a TV programming provider. The targeted advertisement module 226 can use the user profile database 224 to identify users and associated devices that match the user profile type. The targeted advertisement module 226 can then instruct the live stream interface 210 or the on-demand interface 216 to stream the advertisement media segment during allotted timeslots to the matching associated devices.

In some embodiments, an advertiser or a TV programming provider can associate advertisement media segments with a target real-time video watching context (e.g., actively watching for a threshold period of time or actively engaged in an interactive TV segment). The targeted advertisement module 226 can match real-time video watching context reported from the live stream interface 210 and/or the on-demand interface 216 to the target real-time video watching context demanded by the advertiser or the TV programming provider. The targeted advertisement module 226 can then instruct the live stream interface 210 or the on-demand interface 216 to stream the advertisement media segment during allotted timeslots to devices reporting the matching real-time video watching context.

The backend video conversion system 200 maintains a database that logs and tracks activities of subscriber accounts, including interactions with live-streaming content or on-demand content. For example, the user profile database 224 keeps a log and tracks, over time, subscriber accounts' viewing behaviors, such as channel watched, TV shows watched, date and time of viewing, or viewing length (e.g., hours or minutes). The user profile database 224 can cross reference previous records to learn and improve media content suggestions for the subscriber accounts. Accordingly, the user profile database 224 can be used to tailor media contents likely preferred by the viewer associated with a subscriber account.

The user profile database 224 can be used to improve marketing analysis. For example, such analysis can be used by the targeted advertisement module 226 to select targeted and personalized commercial advertisement. The targeted advertisement module 226 can then inject the selected advertisements into a video stream watched by the subscriber account. For example, the injection can be to replace an existing content, a generic advertisement originated from the content provider, a built-in intermission session in the content, or any combination thereof. The live stream converter 208 can intercept a commercial break of a live programming and replace that with an alternative and unique commercial content. The targeted advertisement module 226 can apply the advertisement injections on live broadcasting contents, and/or on-demand contents. In some embodiments, the injected commercial is stored in the transcoded media files (e.g., for on-demand access). In some embodiments, the transcoded media files includes a built-in intermission session where targeted advertisement can be injected after the media file is requested on-demand. For example, when a subscriber account requests, on-demand, a transcoded media file recording (e.g., a TV show from a day or couple hours earlier), the recorded show's commercial contents can be replaced in response to the on-demand request. Live target advertisement is useful to replace irrelevant advertisements with relevant advertisements. For example, if a subscriber accesses a specific show from two weeks ago, commercials shown two weeks ago are outdated and are not relevant to the subscriber/viewer. Accordingly, an outdated commercial is not beneficial for the advertiser neither.

In some embodiments, the live stream interface 210 and/or the on-demand interface 216 can promote media streams identified as being preferred by a subscriber account to a device of the subscriber account when streaming something else. As described above, the backend video conversion system 200 can perform analysis and/or machine learning to learn the preferences of a subscriber account based on logged behavior patterns. These preferences can be used to identify a media stream to promote to the subscriber account. The backend video conversion system 200 can send push-notifications to a subscriber account's local streaming unit, and/or associated mobile device (e.g., running a proprietary application networked with the backend video conversion system 200). These notifications are reminders of the identified media streams that the back-end video conversion system 200 identified that might be relevant to the subscriber's preference.

In several embodiments, the backend video conversion system 200 protects the live video streams and on-demand video streams from being abused by subscriber accounts or from piracy by non-subscribers. The live stream interface 210 and the on-demand interface 216 can secure media streams of stored media content and/or live programming using one or more of the following hardware ID and/or information from the requesting local streaming unit to grant access: a processor ID and/or the processor's serial number, Media Access Control (MAC) address from either a wireless network adapter or an Ethernet adapter, a basic input/output system (BIOS) serial number, a streaming service subscriber account ID, a streaming service subscriber account status (e.g., whether the status corresponds to an active paying subscription), or any combination thereof.

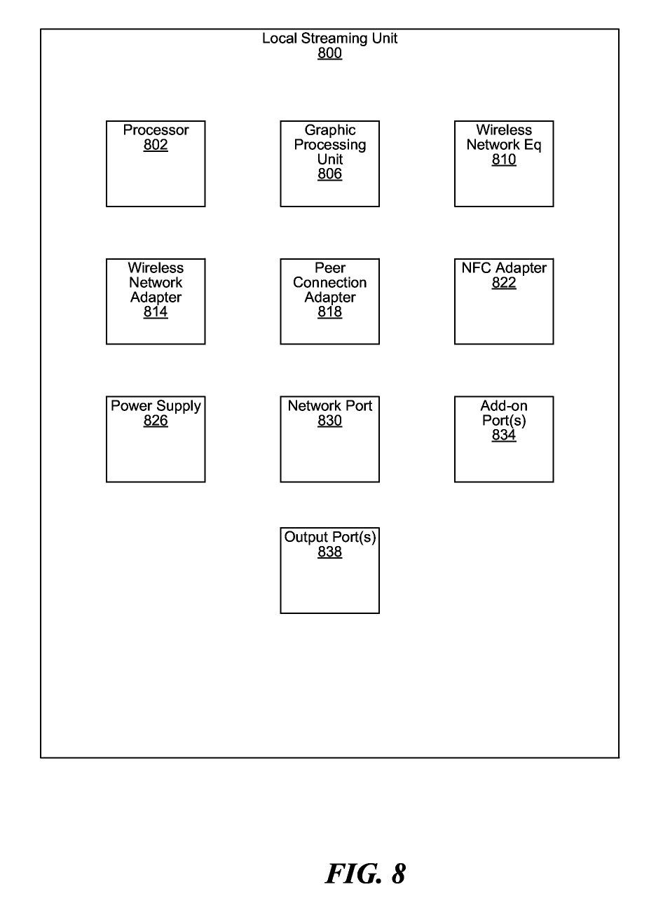

FIG. 8 is a block diagram illustrating a local streaming unit 800 (e.g., the local streaming unit 110), in accordance with various embodiments. In several embodiments, the local streaming unit 800 includes a processor 802, such as a multicore CPU (Central Processing Unit). The local streaming unit 800 can also include a graphic processing unit (GPU) 806, such as a multi-core GPU. The local streaming unit 800 can include a wireless network equipment 810 to generate a wireless network. For example, the wireless network equipment 810 can be a multi-band wireless network router/access point/extender (e.g., transmitter/repeater). The wireless network equipment 810 can join or extend an existing wireless network.

The local streaming unit 800 can include a wireless network adapter 814, such as a multi-band wireless network interface adapter (e.g., a WiFi and/or WiFi-Direct receiver) to connect with smart remote controller 116. In some embodiments, the local streaming unit 800 includes a peer connection adapter 818, such as a Bluetooth wireless interface adapter. The peer connection adapter 818 can pair the local streaming unit 800 with another computing device, such as the smart remote controller 116 and/or other add-on devices. In some embodiments, the local streaming unit 800 includes a near field communication (NFC) adapter 822 to pair with another computing device, such as the smart remote controller 116.

The local streaming unit 800 can include a power supply 826. For example, the power supply 826 can be an internal or external auto-voltage power supply unit. The local streaming unit 800 can include a network port 830, such as a gigabit Ethernet network port for physical networking connection. The local streaming unit 800 can include one or more add-on ports 834 (e.g., for connecting with an add-on device or for obtaining power besides the power supply 826). The add-on ports 834 can include a universal serial bus (USB) port for external add-on or expansion devices, a micro-USB port, a USB Type-C port, or any combination thereof. The local streaming unit 800 can include one or more output ports 838, such as a high definition multimedia interface (HDMI) 2.0/2.0a capable to outputting 4K content at 60p (i.e., 60 frames per second) and High Dynamic Range (HDR) support or a High-bandwidth Digital Content Protection (HDCP) 2.2 for 4K content. In several embodiments, the output ports 838 can be compatible with HDMI-Consumer Electronics Control (CEC) to control a TV set and other HDMI devices.

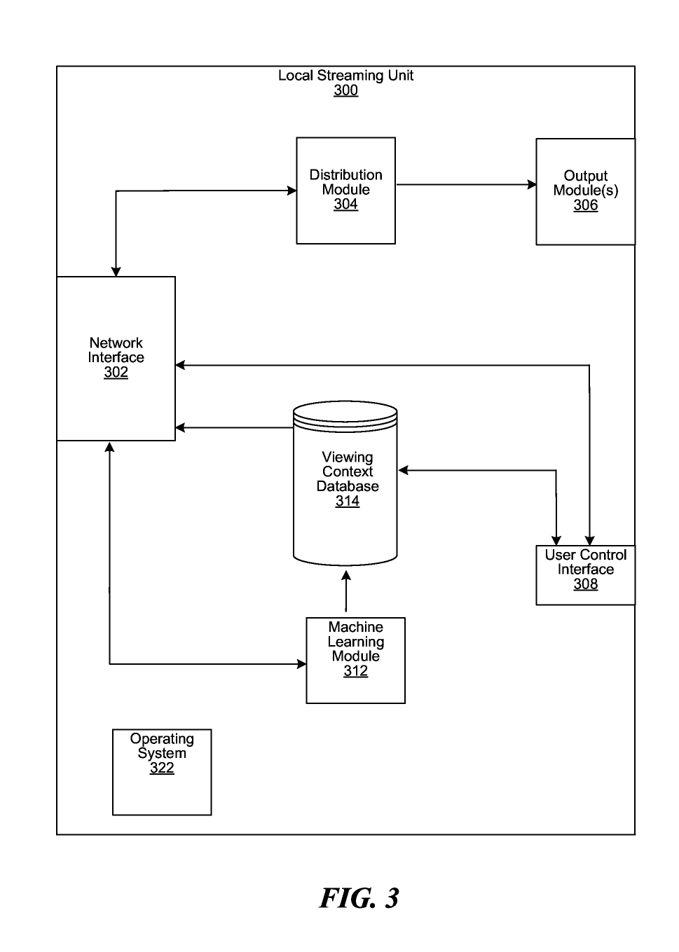

FIG. 3 is a functional block diagram of a local streaming unit 300 (e.g., the local streaming unit 800), in accordance with various embodiments. The local streaming unit 300 includes a network interface 302 that connects to a LAN and/or a global network, such as the Internet. The local streaming unit 300 can implement a distribution module 304 that receives a web-based video stream from a Web server or a web-based API, such as the live stream interface 210 of FIG. 2. The distribution module 304 can then provide raw or compressed video data to one or more of its output modules 306, such as one or more HDMI outputs or one or more wireless or LAN-based video multicast or broadcast component. The distribution module 304 may be responsible for processing (e.g., decoding, decompressing, and/or decrypting) of the received web-based video stream. In some embodiments, the distribution module 304 can also be responsible for re-encoding and/or re-compressing the processed video stream(s). One or more consumer display devices (e.g., a TV, a laptop, a personal computer, a tablet, a smart phone, or any combination thereof) can be in communication with the output modules 306 to read and display the video.

The local streaming unit 300 can include a user control interface 308. The user control interface 308 can generate a user interface controlled by a remote control, such as the smart remote controller 116, a conventional remote, a mobile device (e.g., a tablet, a smart TV, or smartphone running a proprietary application), or any combination thereof. The user control interface 308 can communicate with the remote control. The remote control can authenticate itself as authorized by a subscriber account. The remote control can then access a user profile stored in the user profile database 224 of the backend video conversion system 200. The user profile can be cached on the local streaming unit 300. The user control interface 308 can configure the user interface based on the user profile selected by the remote control.

The user interface can be capable of simultaneously displaying multiple and playback live stream video windows (see e.g., video viewing interface 700). The remote controller can enable navigation within the user interface (e.g., via hand/finger gestures, trackpad motions, voice commands, etc.). In some embodiments, the user control interface 308 can use digitally rendered buttons to detect commands to navigate through the user interface.

The user control interface 308 can receive a command to change a TV channel. In some embodiments, in response to the channel changing command, the user control interface 308 can instruct the distribution module 304 to request a different web-based video stream from a backend server, such as the backend video conversion system 200 of FIG. 2. In some embodiments, in response to the channel changing command, the user control interface 308 can instruct the output modules 306 to display or cause to display a different video stream to the consumer display devices, where the backend server is already streaming that video stream to the local streaming unit 300.

In some embodiments, the local streaming unit 300 can stream multiple TV channels, such as neighboring TV channels, from the backend server. In several embodiments, the digital recording capabilities of the content channels are only on the backend server. That is, in these embodiments, the local streaming unit 300 streams stored video on-demand from the backend server without storing any media content in the local streaming unit 300.

In some embodiments, the local streaming unit 300 can determine how many TV channels to stream simultaneously depending on the bandwidth and/or processing power of the local streaming unit 300. Neighboring TV channels can be defined by the TV programming providers, for example, by their channel numbers, as referenced in cable TV programming or over-the-air TV programming.

The user control interface 308 can receive a command to preview the channels. In response, the distribution module 304 can generate preview windows of the multiple TV channels streamed from the backend server. In some embodiments, the backend server streams a set of one or more high resolution videos and a set of one or more low-resolution videos to the local streaming unit 300. The preview windows can display previews of either or both the high resolution videos and the low-resolution videos. In some embodiments, the preview windows show still image thumbnails of the video contents of a number of TV channels. The still image thumbnails can be periodically updated according to a schedule.

In some embodiments, the user control interface 308 can receive passive updates of video viewing context. The local streaming unit 300 can include a viewing context database 312. The user control interface 308 can store the passive updates in the viewing context database 312. The passive updates may include raw sensor information, operational state information of the remote control, derivative or metadata associated with remote control usage, or any combination thereof. In some embodiments, the local streaming unit 300 can include a machine learning module 314 that computes video viewing behavior model of a user based on the passive updates. In some embodiments, the machine learning module 314 can be implemented in the backend server.

The local streaming unit 300 can implement an operating system 322, such as a proprietary operating system based on Linux. The operating system 322 can be a platform to execute the modules described in the local streaming unit 300 and for facilitating the use of physical components described for the local streaming unit 800.

In several embodiments, the output modules 306 can enable display mirroring between two or more devices connected to the local streaming unit 300 (e.g., via wired or wireless connection). The output modules 306 can be compatible with AirPlay™ Miracast™, WiDi™ (Wireless Display), or any combination thereof. The display mirroring function enables the local streaming unit 300 to serve as a host to reproduce, in real-time, contents shown on external devices (e.g., electronic tablet, smartphones) and use the local streaming unit's connected TV set or display as an extension to enlarge such image/video.

In some embodiments, a remotely located server (e.g., the backend video conversion system 200) can automatically push updates to the local streaming unit 300 via the network interface 302. The updates can be pushed according to a schedule (e.g., periodically) or based on availability of bandwidth and/or the updates. These updates can includes, but not limited to, database for different TV sets, operating system update, user interface or functional module updates, functional profiles, security updates, user profile updates, electronic device profile database updates, or any combination thereof.

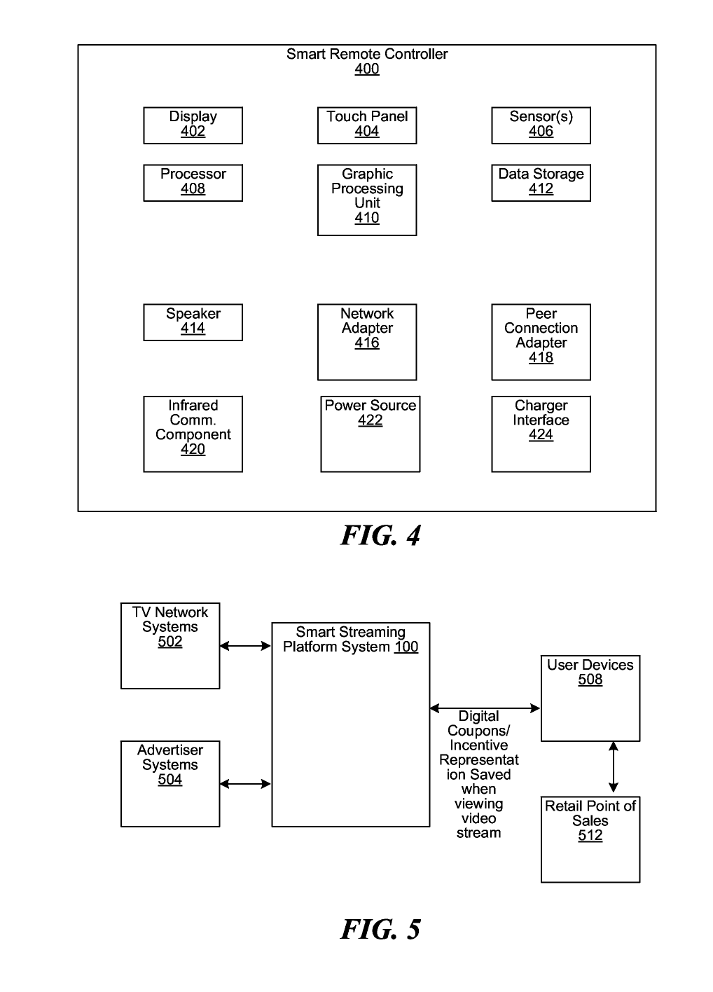

FIG. 4 is a block diagram of a smart remote controller 400, in accordance with various embodiments. The smart remote controller 400, for example, can be the smart remote controller 116 of FIG. 1. The smart remote controller 400 includes a display 402 and a touch panel 404. In some embodiments, the display 402 and the touch panel 404 are integrated together in a touchscreen. The touch panel 404 can be a liquid crystal display (LCD) with multi-touch input capabilities and can function as a trackpad or a touchpad (e.g., a pointing device featuring tactile sensor).

The smart remote controller 400 includes one or more sensors 406, such as a microphone, an ambient light sensor, a tactile sensor, a trackpad, an inertial motion sensor, a temperature sensor, a gyroscope, a light sensor, a camera, a force sensor, a microphone, an electric charge sensor, or any combination thereof. As described above, the sensors 406 can be used to determine video watching context at the home theater environment 112. For example, the sensors 406 can include a microphone to identify a voice command, analyze ambient sound/noise/conversation, and/or perform noise cancellation.

The smart remote controller 400 can include a processor 408, such as a multi-core CPU. In some embodiments, the smart remote controller 400 further a graphic processing unit (GPU) 410, such as a multi-core GPU. The smart remote controller 400 can include a data storage 412 (e.g., a persistent and/or non-persistent computer memory). For example, the data storage 412 can include a flash drive storing an image of the operating system (e.g., the operating system 902) and/or other functional components (e.g., modules, applications, or other software libraries) of the smart remote controller 400.

In some embodiments, the smart remote controller 400 includes a speaker 414. The speaker 414 can reproduce a response to a voice command or ambient noise/sound (e.g., captured by the microphone). The speaker 414 can also reproduce specific ringtones (e.g., alarm, or locator sound indicator) configured by a functional module or by the user.

The smart remote controller 400 can include one or more components to communicate with the local streaming unit 300, the backend video conversion system 200, the TV set, other home theater accessories, or any combination thereof. For example, the smart remote controller 400 can include a network adapter 416, a peer connection adapter 418, or a combination thereof. For example, the network adapter 416 can be a wireless network interface adapter four Wi-Fi and/or Wi-Fi Direct. In one example, the peer connection adapter 418 is a Bluetooth wireless interface adapter capable of pairing with the local streaming unit 300. In another example, the peer connection in some embodiments, the remotest adapter 418 is NFC adapter capable of pairing with the local streaming unit 300. In some embodiments, the smart remote controller 400 includes an infrared communication component 420 (e.g., consistent with the Infrared Data Association (IrDA) standards). The infrared communication component 420 can be an infrared transmitter, infrared receiver, or a combination thereof.

The smart remote controller 400 includes a power source 422 (e.g., a battery). In several embodiments, the smart remote controller 400 includes a charger interface 424. The charger interface 424 interfaces with an external wireless charging dock (e.g., the charging dock 118) designed to charge the smart remote controller 400. The charger interface 424 can recharge the power source 422 from a wireless or wired source. The external wireless charging dock can include a remote controller locator button, which when pressed, sends a signal to the smart remote controller 400 to cause the speaker 414 to produce a sound (e.g., a high-pitched sound) and/or the display 422 produce a certain image or animation (e.g., flashing white light). When the smart remote controller 400 is nested and charging on the charging dock, the operating system (e.g. the operating system 902) can trigger the stream control interface 906 to display a digital clock on the display 402. The digital clock can also provide a programmable alarm function. The alarm function can be disabled by swiping the instruction shown on the display 402. Alternatively, when the smart remote controller 400 is removed from the charging dock, the stream control interface 906 turns off the alarm function and sends command to its paired local streaming unit to power-up/resume from standby.

In some embodiments, the sensors 406 includes a proximity sensor (e.g., optically-based sensor, magnetically based sensor, electrical contact based sensor) that detects whether the display 402 and/or the touch panel 404 of the smart remote controller 400 is facing down on a surface (e.g., a table, a desk, a sofa, a couch, a bed, a chair, etc.). The network adapter 416 and/or the peer connection adapter 418 can be configured to send a command to power down (or put in a standby mode) its paired local streaming unit. The peer connection adapter for generating and/or the infrared communication component 420 can send a command to power down (or put in a standby mode) its paired TV set. In some embodiments, the command can be sent to the TV set via the local streaming unit (e.g., via HDMI-CEC).

In some embodiments, the sensors 406 include an ambient-light sensor to detect a surrounding lightning condition of the smart remote controller 400. The processor 408 can be configured to trigger a display output tuning by sending a command to its paired local streaming unit to adjust its output brightness (e.g., via a HDMI port) or display brightness of a TV set via the HDMI-CEC protocol

In some embodiments, sensors 406 include a gyroscope and an accelerometer to adjust the smart remote controller 400's function to match user's behavior. In one example, in response to detecting a rotation of the smart remote controller 400 from a vertical orientation (e.g., portrait mode) to a horizontal orientation (e.g., landscape mode), the smart remote controller 400 switches on an on-screen digital keyboard. In another example, in response to detecting movement of the smart remote controller 400 after a preset period of time, the smart remote controller 400 sends a command to its paired local streaming unit to power up or resume from standby operation.

In some embodiments, a remotely located server (e.g., the backend video conversion system 200) can automatically push updates to the smart remote controller 400 via the network adapter 416. The updates can be pushed according to a schedule (e.g., periodically) or based on availability of bandwidth and/or the updates. These updates can includes, but not limited to, database for different TV sets, operating system update, user interface or functional module (e.g., application) updates, functional profiles, security updates, user profile updates, electronic device profile database updates, or any combination thereof.

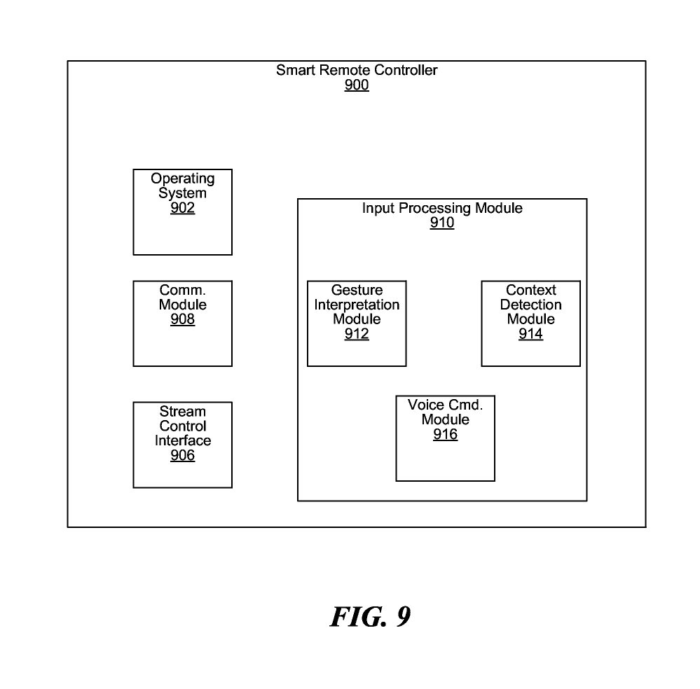

FIG. 9 is a functional block diagram illustrating a smart remote controller 900 (e.g., the remote controller 400), in accordance with various embodiments. The smart remote controller 900 can implement an operating system 902. The operating system 902 can be a proprietary operating system based on the Linus kernel. One or more functional modules can be implemented to run on the operating system 902. For example, the smart remote controller 900 can include a stream control interface 906. The stream control interface 906 can store and activate one or more commands to control a local streaming unit (e.g., the local streaming unit 300 and/or the local streaming unit 800). These commands can include hiring the local streaming unit on and off, adjusting the output volume from the video streams, switching between channels of video streams, specifying an input source, configuring a network established or joined by the local streaming unit, or other controls of TV sets and/or electronic of devices attached to the local streaming unit or in a network connected to the smart remote controller 400.

The smart remote controller 900 can include a communication module 908. The communication module 908 can be adapted to communicate via, for example, radio frequency (RF), infrared (IR), Bluetooth, Wi-Fi, Wi-Fi direct (WFD), near field communication (NFC), or any combination thereof to a streaming system box, such as the local streaming unit of FIG. 3. Short range communication protocols, such as the NFC, can be used for pairing the smart remote controller 900 with the streaming system box.

In some embodiments, the smart remote controller 900 includes an input processing module 910. For example, the input processing module 910 can process a keyboard inputs from a user (e.g., from physical buttons of a physical keyboard or from a touchscreen displaying a virtual keyboard). The input processing module 910 can support multi-language input via a digital keyboard (e.g., implemented by the touch panel 404 or one or more of the sensors 406). The input processing module 910 can further include a gesture interpretation module 912 (e.g., providing hand or a finger gesture stroke input), a context detection module 914, a voice command module 916, or any combination thereof.

The gesture interpretation module 912 monitors the touch panel 404 and/or the sensors 406 to determine whether the user is issuing a command by gesturing. For example, when the smart remote controller 900 is rotated 90°, a display switch command can be issued. The display switch command can cause the display 402 on the smart remote controller 900 to turn on or turn off, depending on whether the display 402 is already turned on or off. For example, when the display 402 is turned on, a virtual keyboard can be displayed for the user to input text to the streaming system box. For another example, when a swipe gesture detected on an edge region of the touch panel 404 can issue an open menu command to cause the streaming system box to display a TV control menu. A swipe gesture detected in a non-edge region of the touch panel 404 can issue a channel changing command. A swipe gesture upward or downward to issue an interface scrolling command to the streaming system box. In some embodiments, the gesture interpretation module 912 can determine whether a user is left-handed or right-handed based on the sensors 406. The gesture interpretation can adjust according to whether the user is left-handed or right-handed.

The context detection module 914 can monitor a video viewing context by maintaining multiple operational states. For example, the operational state can include an active watching state, channel searching state, passive watching state, user absence state, multiple-viewers-present state, or any combination thereof. The context detection module 914 can determine the operational states based on sensor information from the touch panel 404 and the sensors 406. In some embodiments, the context detection module 914 is implemented in the streaming system box (e.g., where the smart remote controller 900 sends the sensor information from the touch panel 404 and the sensors 406 directly to the streaming system box).

The voice command module 916 can provide voice-to-text or voice-to-command processing. For example, the voice command module 916 can be configured to determine a command available to the stream control interface 906. In response, the stream control interface 906 can execute the determined command to configure the local streaming unit or other electronic devices paired or networked with the local streaming unit and/or the smart remote controller 900.

FIG. 5 is an expanded system environment diagram for using the smart streaming platform system 100 (e.g., utilizing the backend video conversion system 200) to distribute electronic incentive identifiers, in accordance with various embodiments. The smart streaming platform system 100 can act as agents of TV network systems 502 by providing an interface (e.g., the media control interface 220 of FIG. 2) to control and secure the live streaming and on-demand streaming from a backend video conversion system, such as the backend video conversion system 200 of FIG. 2. The TV network systems 502 can assign timeslots during the live streaming or on-demand streaming sessions to advertiser systems 504, such as retail stores. In various embodiments, the same timeslot for a single TV channel can be assigned to multiple of the advertiser systems 504. The advertiser systems 504 can send indications of target user profiles or target real-time video watching context associated with each advertisement media segment to the backend video conversion system. The backend video conversion system can then stream the advertisement media segment to devices that match the target user profiles and/or the target real-time video watching context.

In some embodiments, the advertiser systems 504 can provide electronic product or service incentive identifiers (e.g., loyalty points or coupons) through the advertisement media segments. The identifiers can be used to redeem a price reduction or other benefits and then tracked to monitor the conversion efficiency of the TV channels. For example, a streaming system box (e.g., the local streaming unit 300 of FIG. 3) coupled to the backend video conversion system can enable a viewer to interact with an advertisement media segment through a remote control (e.g., the smart remote controller 400 of FIG. 4). The viewer, for example, can collect the electronic incentives in a user device 508 (e.g., a smart phone, a wearable device, or a tablet). The electronic incentives can include one or more methods of identifying itself, such as a bar code, an identifier number, a QR code, etc. The electronic incentives can then be used in common retail stores (e.g., at a retail point of sale (POS) 512) to redeem a benefit from the advertiser systems 504. Upon redemption, the smart streaming system can update conversion statistics associated with that particular advertisement shown in that particular TV channel.

Portions of components (e.g., including hardware components, executable modules implemented by executable instructions to configure a logic computation device, such as a processor, data storage, or any combination thereof) associated with the smart streaming platform system 100, the backend video conversion system 200, the local streaming unit 300, or the smart remote controller 400, may be implemented, partially or in whole, in the form of special-purpose circuitry, in the form of one or more appropriately programmed programmable processors, a single board chip, a field programmable gate array, a network capable computing device, a virtual machine, a cloud-based terminal, or any combination thereof. The components may be hardware-based, firmware-based, software-based, or any combination thereof. For example, the components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not transitory signal. Memory space and storages described in the figures can be implemented with the tangible storage memory as well, including volatile or non-volatile memory.

Each of the components may operate individually and independently of other components. Some or all of the components may be executed on the same host device or on separate devices. The separate devices can be coupled through one or more communication channels (e.g., wireless or wired channel) to coordinate their operations. Some or all of the components may be combined as one component. A single component may be divided into sub-components, each sub-component performing separate method step or method steps of the single component.

In some embodiments, at least some of the components share access to a memory space. For example, one component may access data accessed by or transformed by another component. The components may be considered “coupled” to one another if they share a physical connection or a virtual connection, directly or indirectly, allowing data accessed or modified from one component to be accessed in another component. In some embodiments, at least some of the components can be upgraded or modified remotely (e.g., by reconfiguring executable instructions that implements a portion of the components).

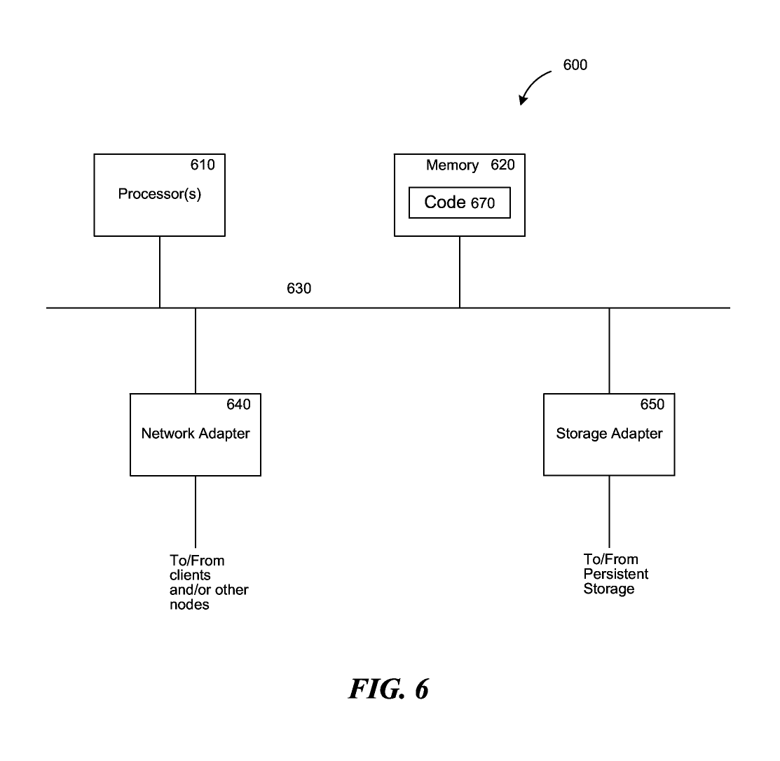

FIG. 6 is a block diagram of an example of a computing device 600, which may represent one or more computing device or server described herein, in accordance with various embodiments. The computing device 600 can be one or more computing devices that implement the smart streaming platform system 100 of FIG. 1 or the backend video conversion system 200 of FIG. 2 or methods and processes described in this disclosure. The computing device 600 includes one or more processors 610 and memory 620 coupled to an interconnect 630. The interconnect 630 is an abstraction that represents any one or more separate physical buses, point-to-point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard bus, also called “Firewire”.

The processor(s) 610 is/are the central processing unit (CPU) of the computing device 600 and thus controls the overall operation of the computing device 600. In certain embodiments, the processor(s) 610 accomplishes this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 620 is or includes the main memory of the computing device 600. The memory 620 represents any form of random access memory (RAM), read-only memory (ROM), flash memory, or the like, or a combination of such devices. In use, the memory 620 may contain a code 670 containing instructions according to the mesh connection system disclosed herein.

Also connected to the processor(s) 610 through the interconnect 630 are a network adapter 640 and a storage adapter 650. The network adapter 640 provides the computing device 600 with the ability to communicate with remote devices, over a network and may be, for example, an Ethernet adapter or Fibre Channel adapter. The network adapter 640 may also provide the computing device 600 with the ability to communicate with other computers. The storage adapter 650 enables the computing device 600 to access a persistent storage, and may be, for example, a Fibre Channel adapter or SCSI adapter.

The code 670 stored in memory 620 may be implemented as software and/or firmware to program the processor(s) 610 to carry out actions described above. In certain embodiments, such software or firmware may be initially provided to the computing device 600 by downloading it from a remote system through the computing device 600 (e.g., via network adapter 640).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

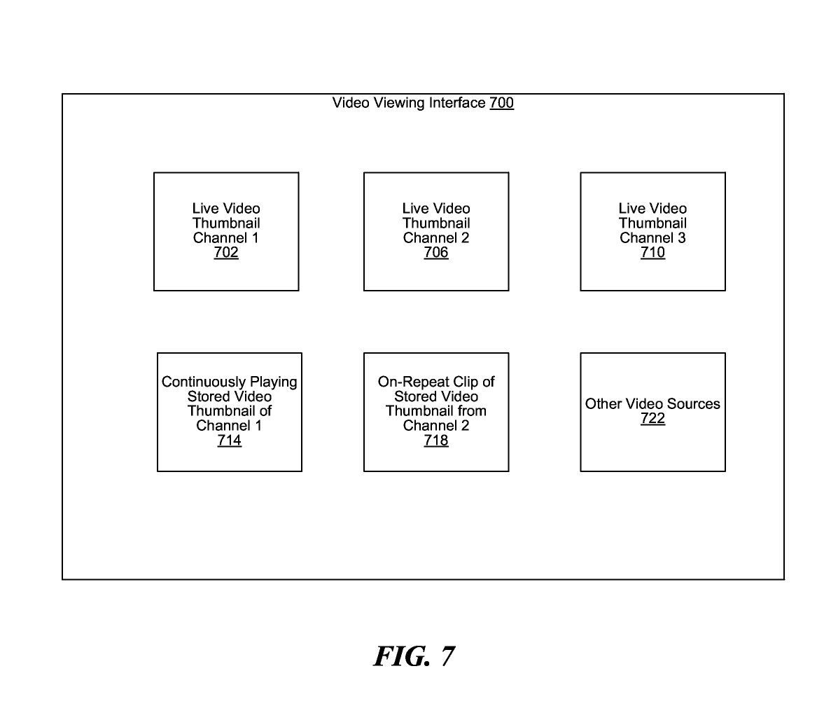

FIG. 7 is an example of a video viewing interface 700 generated by a local streaming unit (e.g., the local streaming unit 110, the local streaming unit 300, and/or the local streaming unit 800), in accordance with various embodiments. The video viewing interface 700 can display live and/or on-demand videos. In the home screen (as shown), the video viewing interface 700 simultaneously plays videos (e.g., live from a content channel or on-demand from stored media files of the backend video conversion system 200) in video windows. Each of the video windows can be simultaneously playing videos with an audio output. In the illustrated example, a video window 702 plays a live video from “channel 1.” The live video can be at a lower resolution. Similarly, a video window 706 and a video window 710 respectively play videos from “channel 2” and “channel 3.”

A video window 714 continuously plays a stored video file recorded from “channel 1.” A video window 718 plays a clip from a stored video file recorded from “channel 2” on-repeat. A video window 722 plays a video file from a media sharing website or a web video website. In several embodiments, the video viewing interface 700 can be streaming TV channels whose identifiers are numerical or alphabetically contiguous neighbors within a preset range (e.g., +/−3 channels from the currently selected content provider channel) to enable web-based channel browsing on a single computing device without unnecessary loading delay.

Some embodiments of the disclosure have other aspects, elements, features, and steps in addition to or in place of what is described above. These potential additions and replacements are described throughout the rest of the specification. For example, some embodiments include a computer-implemented method (e.g., programmed as executable instructions that can configure one or more processors) to operate a computer server system. The computer server system receives an input feed of a television (TV) channel programming. The computer server system transcodes in real-time or substantially real-time, the input feed into a web-accessible video stream. The computer server system can provide live distribution by transmitting the web-accessible video stream live to multiple user devices such that the TV channel programming is in sync or substantially in sync with the transmitted web-accessible video stream. The computer server system can record the web-accessible video stream in a media storage (e.g., in the computer server system, CDN, data centers, or other cloud storage) protected by an authentication engine. The authentication engine can provide restricted access to on-demand distribution of the recorded web-accessible video stream. The computer server system can generate a channel-side control interface coupled to the authentication engine and available to an authorized account associated with the TV channel programming. The channel-side control interface can enable access control of the live distribution of the web-accessible video stream or the on-demand distribution of the recorded web-accessible video stream.

In some embodiments, the computer server system can limit on-demand viewing of the recorded web-accessible video stream based on a user profile associated with a viewing device. In some embodiments, the input feed is delivered via a TV cable according to a cable TV encoding standard and not a computer network interconnection (e.g., Ethernet or WiFi).

In some embodiments, transcoding of the input feed includes generating multiple web-accessible video streams with different targeted advertisements placed into a synchronized time slot in the web-accessible video streams to provide to the multiple user devices. For example, the computer server system can record viewing behaviors of the multiple user devices and determine the targeted advertisements based on user profiles of the multiple user devices, the viewing behaviors, or a combination thereof. The synchronized time slot can be a time slot of an existing advertisement in the input feed for replacement by one of the targeted advertisements or a content-less portion of the input feed.

In some embodiments, the computer server system can stream the recorded web-accessible video stream to a user device, in response to an on-demand video request. The computer server system can identify a targeted advertisement based on a user profile or a user video viewing history of a subscriber account that initiated the on-demand video request. The computer server system can place the targeted advertisement into the recorded web-accessible video stream, in response to the on-demand video request.

In some embodiments, the computer server system transmits multiple web-accessible video streams live to a single computing device to be displayed simultaneously on the single computing device. The multiple web-accessible video streams can correspond to TV channels whose identifiers are numerically or alphabetically contiguous neighbors to enable channel browsing on the single computing device.

In some embodiments, the web-accessible video stream is recorded in the media storage continuously as the web-accessible video stream is being transmitted to the multiple user devices. In some embodiments, the web-accessible video stream is recorded sequentially as fragments. The computer server system can encrypt the fragments corresponding to the web-accessible video stream from the TV channel programming. The encryption can be based on a cryptographic key provided from a computer system associated with the TV channel programming.

In some embodiments, the computer server system can receive a distribution privilege update for the TV channel programming via the channel-side control interface. The computer server system can prevent, in real-time or substantially real-time, the live distribution of the web-accessible video stream or the on-demand distribution of the recorded web-accessible video stream, in response to receiving the distribution privilege update. In some embodiments, the computer server system can specify a channel-specific subscriber viewing restriction in response to receiving the distribution privilege update. In one example, the channel-specific subscriber viewing restriction specifies a user profile characteristic of active subscriber accounts as a positive filter or a negative filter to grant access to the live distribution or the on-demand distribution. In another example, the channel-specific subscriber viewing restriction specifies a device characteristic or device identifier of active subscriber accounts as a positive filter or a negative filter to grant access to the live distribution or the on-demand distribution. In yet another example, the channel-specific subscriber viewing restriction specifies a characteristic of viewer behavior histories of active subscriber accounts as a positive filter or a negative filter to grant access to the live distribution or the on-demand distribution.

Several embodiments include a local streaming unit. The local streaming unit includes a processor configured to implement a proprietary operating system to host a video viewing user interface. The local streaming unit includes a display output port configured to connect with a television (TV) set to display the video viewing user interface. The local streaming unit includes a network adapter configured to receive multiple video streams from a backend server system. The local streaming unit can include a graphic processing unit (GPU) configured to render the multiple video streams as simultaneously displayed windows in the video viewing user interface. The local streaming unit can include a peer connection adapter configured to pair with a remote controller. Each of the simultaneously displayed windows is capable of being expanded to full screen in response to a user-initiated command from the remote controller. The peer connection adapter can be configured to receive a channel-browsing command from the remote controller. The processor is configured to switch between the displayed window In response to the channel-browsing command. In some embodiments, the GPU is configured to render 4K content encoded under HEVC/H.265 compression standard or VP10 compression standard.

Several embodiments include a remote control. The remote control includes a peer connection adapter configured to pair with a local video streaming equipment. The remote control includes a touch panel configured to sense touch motions and/or an inertial sensor configured to detect device motions of the remote control. The remote control includes a processor configured to identify a channel browsing gesture based on the touch motions, the device motions, or a combination thereof. The processor can generate a channel browsing command to send through the peer connection adapter in response to identifying the channel browsing gesture.

In some embodiments, the remote control includes a display integrated with the touch panel. In some embodiments, the remote control includes a speaker configured to deliver notification from the local video streaming equipment or to sound a user-specified alarm. In some embodiments, the remote control includes a battery and a wireless charger interface adapted to charge the battery by harvesting energy wirelessly from a wireless charging dock. In some embodiments, the remote control includes an infrared communication component configured to communicate with a TV set.

In some embodiments, the remote control includes a microphone configured to perform noise cancellation. In some embodiments, the remote control includes a microphone configured to record ambient sound. The processor can be configured to interpret the ambient sound into a voice command or send the ambient sound to the local video streaming equipment for interpretation. In some embodiments, the remote control includes an ambient light sensor configured to measure surrounding lighting condition of the remote control. The processor can be configured to send a command to the local video streaming equipment to adjust a display brightness setting based on the measured surrounding lighting condition. In some embodiments, the remote control includes a proximity sensor configured to detect whether the touch panel is faced down toward a surface. The processor can be configured to send a command to the local video streaming equipment to power off or go into standby when the touch panel is detected to be faced down toward the surface.

In some embodiments, the processor is configured to record viewer behavior characterized by one or more sensors including the inertial sensor, the touch panel, or a combination thereof. The processor can send the recorded viewer behavior to the local video streaming equipment to associate with a video content being watched.

What is claimed is:

1. A computer-implemented method comprising:
receiving, by a computer server system, an input feed of a television (TV) channel programming;
transcoding, by the computer server system in real-time or substantially real-time, the input feed into a web-accessible video stream;
providing live distribution via the computer server system by transmitting the web-accessible video stream live to multiple user devices such that the TV channel programming is in sync or substantially in sync with the transmitted web-accessible video stream;
recording the web-accessible video stream in a media storage protected by an authentication engine, wherein the authentication engine provides restricted access to on-demand distribution of the recorded web-accessible video stream; and
generating a channel-side control interface, coupled to the authentication engine and available to an authorized account associated with the TV channel programming, to enable access control of the live distribution of the web-accessible video stream or the on-demand distribution of the recorded web-accessible video stream.

2. The computer-implemented method of claim 1, further comprising limiting on-demand viewing of the recorded web-accessible video stream based on a user profile associated with a viewing device.

3. The computer-implemented method of claim 1, wherein the input feed is delivered via a TV cable according to a cable TV encoding standard and not a computer network interconnection.

4. The computer-implemented method of claim 1, wherein transcoding the input feed includes generating multiple web-accessible video streams with different targeted advertisements placed into a synchronized time slot in the web-accessible video streams to provide to the multiple user devices.

5. The computer-implemented method of claim 4, further comprising:
recording viewing behaviors of the multiple user devices; and
determining the targeted advertisements based on user profiles of the multiple user devices, the viewing behaviors, or a combination thereof.

6. The computer-implemented method of claim 4, wherein the synchronized time slot is a time slot of an existing advertisement in the input feed for replacement by one of the targeted advertisements or a content-less portion of the input feed.

7. The computer-implemented method of claim 1, further comprising streaming the recorded web-accessible video stream to a user device, in response to an on-demand video request.

8. The computer-implemented method of claim 7, further comprising:
identifying a targeted advertisement based on a user profile or a user video viewing history of a subscriber account that initiated the on-demand video request; and
placing the targeted advertisement into the recorded web-accessible video stream, in response to the on-demand video request.

9. The computer-implemented method of claim 1, wherein transmitting the web-accessible video stream live includes transmitting multiple web-accessible video streams live to a single computing device to be displayed simultaneously on the single computing device.

10. The computer-implemented method of claim 9, wherein the multiple web-accessible video streams correspond to TV channels whose identifiers are numerically or alphabetically contiguous neighbors to enable channel browsing on the single computing device.

11. The computer-implemented method of claim 1, wherein the web-accessible video stream is recorded in the media storage continuously as the web-accessible video stream is being transmitted to the multiple user devices.

12. The computer-implemented method of claim 1, wherein the web-accessible video stream is recorded sequentially as fragments, wherein the computer-implemented method further comprises encrypting the fragments corresponding to the web-accessible video stream from the TV channel programming, and wherein said encrypting is with a cryptographic key provided from a computer system associated with the TV channel programming.

13. The computer-implemented method of claim 1, further comprising:
receiving, by the computer server system, a distribution privilege update for the TV channel programming via the channel-side control interface; and
preventing, in substantially real-time, the live distribution of the web-accessible video stream or the on-demand distribution of the recorded web-accessible video stream, in response to receiving the distribution privilege update.

14. The computer-implemented method of claim 1, further comprising:
receiving, by the computer server system, a distribution privilege update for the TV channel programming via the channel-side control interface; and
specifying a channel-specific subscriber viewing restriction in response to receiving the distribution privilege update.

15. The computer-implemented method of claim 14, wherein the channel-specific subscriber viewing restriction specifies a user profile characteristic of active subscriber accounts as a positive filter or a negative filter to grant access to the live distribution or the on-demand distribution.

16. The computer-implemented method of claim 14, wherein the channel-specific subscriber viewing restriction specifies a device characteristic or device identifier of active subscriber accounts as a positive filter or a negative filter to grant access to the live distribution or the on-demand distribution.

17. The computer-implemented method of claim 14, wherein the channel-specific subscriber viewing restriction specifies a characteristic of viewer behavior histories of active subscriber accounts as a positive filter or a negative filter to grant access to the live distribution or the on-demand distribution.

18. A computer server system comprising:
computer memory device configured to store executable instructions;
one or more processors configured by the executable instructions to:
receive an input feed of a content provider channel programming;
receive an input feed of a television (TV) channel programming;
transcode, in real-time or substantially real-time, the input feed into a web-accessible video stream;
provide live distribution by transmitting the web-accessible video stream live to multiple user devices such that the TV channel programming is in sync or substantially in sync with the transmitted web-accessible video stream;
record the web-accessible video stream in a media storage protected by an authentication engine;
provide, via the authentication engine, restricted access to on-demand distribution of the recorded web-accessible video stream; and
generate a channel-side control interface, coupled to the authentication engine and available to an authorized account associated with the TV channel programming, to enable access control of the live distribution of the web-accessible video stream or the on-demand distribution of the recorded web-accessible video stream.

19. A local streaming unit comprising:
a processor configured to implement a proprietary operating system to host a video viewing user interface;
a display output port configured to connect with a television (TV) set to display the video viewing user interface;
a network adapter configured to receive multiple video streams from a backend server system;
a graphic processing unit (GPU) configured to render the multiple video streams as simultaneously displayed windows in the video viewing user interface; and
a peer connection adapter configured to pair with a remote controller;
wherein each of the simultaneously displayed windows is capable of being expanded to full screen in response to a user-initiated command from the remote controller;
wherein the peer connection adapter is configured to receive a channel-browsing command; and
wherein the processor is configured to switch between the displayed window in response to the channel-browsing command.

20. The local streaming unit of claim 19, wherein the GPU is configured to render 4K content encoded under HEVC/H.265 compression standard or VP10 compression standard.

21. A remote control comprising:
a peer connection adapter configured to pair with a local video streaming equipment;
a touch panel configured to sense touch motions;
an inertial sensor configured to detect device motions of the remote control; and
a processor configured to identify a channel browsing gesture based on the touch motions, the device motions, or a combination thereof, and to generate a channel browsing command to send through the peer connection adapter in response to identifying the channel browsing gesture.

22. The remote control of claim 21, further comprising a display integrated with the touch panel.

23. The remote control of claim 21, further comprising a speaker configured to deliver notification from the local video streaming equipment or to sound a user-specified alarm.

24. The remote control of claim 21, further comprising: a battery and a wireless charger interface adapted to charge the battery by harvesting energy wirelessly from a wireless charging dock.

25. The remote control of claim 21, further comprising an infrared communication component configured to communicate with a TV set.

26. The remote control of claim 21, wherein the processor is configured to record viewer behavior characterized by one or more sensors including the inertial sensor, the touch panel, or a combination thereof, and to send the recorded viewer behavior to the local video streaming equipment to associate with a video content being watched.

27. The remote control of claim 21, further comprising a microphone configured to perform noise cancellation.

28. The remote control of claim 21, further comprising a microphone configured to record ambient sound; and wherein the processor is configured to interpret the ambient sound into a voice command or send the ambient sound to the local video streaming equipment for interpretation.

29. The remote control of claim 21, further comprising an ambient light sensor configured to measure surrounding lighting condition of the remote control; and wherein the processor is configured to send a command to the local video streaming equipment to adjust a display brightness setting based on the measured surrounding lighting condition.

30. The remote control of claim 21, further comprising a proximity sensor configured to detect whether the touch panel is faced down toward a surface; and wherein the processor is configured to send a command to the local video streaming equipment to power off or go into standby when the touch panel is detected to be faced down toward the surface.
